(19) United States
(12) Patent Application Publication
(10) Pub. No.: US 2026/0270901 A1
(43) Pub. Date: Sep. 10, 2026

(54) INITIAL ACCESS COEXISTENCE WITH DEDICATED FREQUENCY RANGE 1 SPECTRUM LESS THAN 5 MEGAHERTZ VIA CELL SEARCH PRUNING

(71) Applicant: APPLE INC., Cupertino, CA (US)

(72) Inventors: Rolando E Bettancourt Ortega, Munich (DE); Jie Cui, San Jose, CA (US); Herbert R Dawid, Herzogenrath, North Rhine-Westphalia (DE); Yang Tang, San Jose, CA (US); Qiming Li, Beijing (CN); Xiang Chen, Campbell, CA (US)

(21) Appl. No.: 19/164,983

(22) PCT Filed: Apr. 4, 2023
(86) PCT No.: PCT/CN2023/086183

§ 371 Date: Sep. 12, 2025

(51) Int. Cl. H04W 56/00; H04J 11/00; H04L 5/00

(52) U.S. Cl. CPC H04W 56/0015; H04J 11/0073; H04J 11/0076; H04L 5/0051

(57) ABSTRACT

Systems and methods for initial access coexistence with dedicated frequency range 1 (FR1) spectrum that is less than 5 megahertz (MHz) with spectrum that is 5 MHz or greater via the use of cell search pruning are described herein. A user equipment (UE) may receive a synchronization signal (SS)/physical broadcast channel (PBCH) block (SSB) at a raster point of a frequency raster used for identifying channels having channel bandwidths of less than 5 MHz, may identify that a channel corresponding to the SSB has a bandwidth that is less than 5 MHz based on a formulation of a PBCH of the SSB, and may use, based on the SSB, the channel to synchronize to a cell. Radio access network (RAN) behaviors related to the formulation of such PBCHs of such SSBs are also disclosed. Some embodiments for formulating such PBCHs contemplate particular arrangements for PBCH demodulation reference signals (DMRSs).

### TECHNICAL FIELD

This application relates generally to wireless communication systems, including wireless communication systems enabling the deployment and use of channel bandwidths that are less than 5 MHz.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

Frequency bands for 5G NR may be separated into two or more different frequency ranges. For example, Frequency Range 1 (FR1) may include frequency bands operating in sub-6 gigahertz (GHz) frequencies, some of which are bands that may be used by previous standards, and may potentially be extended to cover new spectrum offerings from 410 megahertz (MHz) to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mmWave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an SSB, according to an embodiment.

FIG. 2 illustrates a table showing GSCN parameters for a global frequency network.

FIG. 3 illustrates a table illustrating formulas for determining a mapping of a PBCH DMRS in an SSB.

FIG. 4 illustrates an SSB corresponding to a sub-5 MHz channel, according to embodiments herein.

FIG. 5 illustrates an SSB corresponding to a sub-5 MHz channel, according to embodiments herein.

FIG. 6 illustrates a method of a UE, according to embodiments herein.

FIG. 7 illustrates a method of a RAN, according to embodiments herein.

FIG. 8 illustrates an example architecture of a wireless communication system, according to embodiments disclosed herein.

FIG. 9 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

It has been determined to enhance support in wireless communication systems (e.g., NR systems) corresponding to the use of (e.g., dedicated) spectrum that is less than 5 MHz (e.g., for FR1). Support for such uses may be of particular benefit in, for example, future railway mobile communication system (FRMCS) contexts as understood by 3GPP (but note that these contexts are given by way of example and not by way of limitation).

Various corresponding objectives may be considered for dedicated frequency division duplex (FDD) spectrum in FR1 in such cases.

A first such objective may be to identify and specify beneficial changes to NR physical layer constructions, with consideration towards minimizing specification impacts for the same, in order to allow an NR wireless communication system to operate with spectrum allocations from approximately 3 MHz up to (e.g., values just below) 5 MHz.

In such circumstances, it may be that a subcarrier spacing (SCS) is restricted to 15 kHz and the use of a typical cyclic prefix (e.g., per specification) is anticipated.

Further, with respect to synchronization signal (SS)/physical broadcast channel (PBCH) block (SSB) design, it may be desirable to reuse primary synchronization signals (PSSs)/secondary synchronization signals (SSSs) as presently specified and without puncturing. Further, modifications to PBCHs of such SSBs may take as a starting point a presently specified PBCH design.

Still further, it may be beneficial in such circumstances to identify and specify (minimized) changes to one or more of physical downlink control channels (PDCCHs), channel state information reference signals (CSI-RSs)/tracking reference signals (TRSs), physical uplink control channels (PUCCHs), and/or physical random access channels (PRACHs) for functional support based on their existing specified designs, without optimization.

A second objective may be to specify RAN requirements to support system deployment (e.g., of an NR system) that uses spectrum allocations from approximately 3 MHz up to (e.g., values just below) 5 MHz. With respect to 3GPP networks, this may include within, for example, bands n100, n8, n26 and n28.

In such circumstances, it may be beneficial to specify system parameters (including channel and synchronization raster(s)) for the associated dedicated spectrum.

Further, it may be beneficial to minimize an impact on radio frequency (RF) requirements (e.g., with respect to previously specified systems). For example, it may be beneficial to reuse 5 MHz channel bandwidths at least for FRMCS use cases (e.g., in a case of co-located NR and GSM-railway (GSM-R) systems having a same operator), and to further specify RF requirements for an optional 3 MHz channel bandwidth in bands n100, n8, n26 and n28.

Still further, it may be beneficial in such circumstances to specify radio resource management (RRM) requirements while minimizing impacts to existing specification(s) in order to support wireless communication system operation in dedicated spectrum allocations from approximately 3 MHz up to (e.g., values just below) 5 MHz.

### Embodiments of SSB Size Reduction for Channel Bandwidths Less than 5 MHz

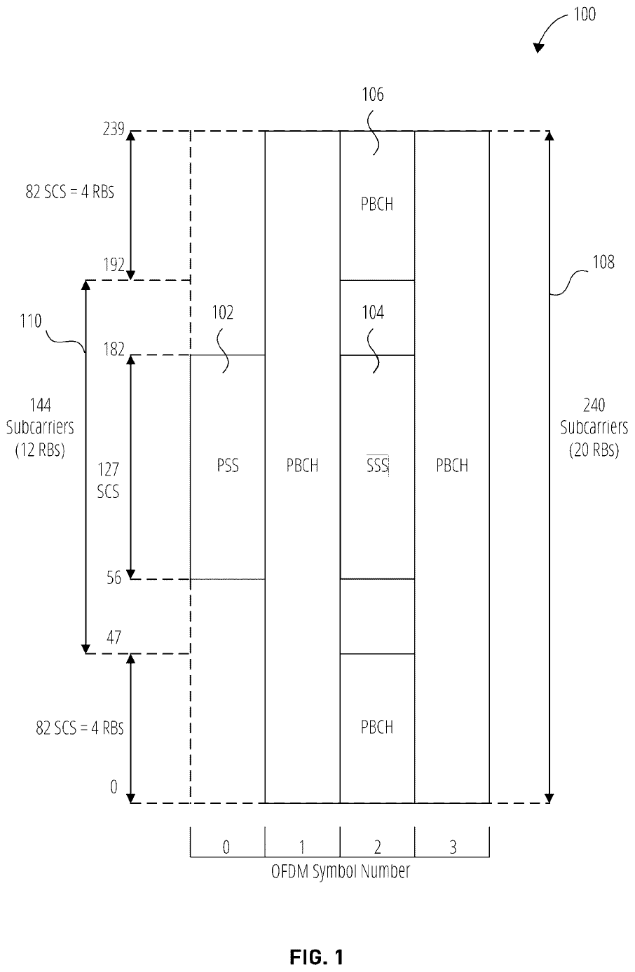

FIG. 1 illustrates an SSB 100, according to an embodiment. The SSB 100 may be arranged according to a definition found in a specification for a wireless communication system (e.g., an NR specification). When received by a UE, the SSB 100 may enable the UE to synchronize and camp to a cell. As may be seen, the SSB 100 includes a PSS 102, an SSS 104, and a PBCH 106.

As illustrated, the PBCH 106 is transmitted within a bandwidth of 20 resource blocks (RBs) 108, and that the 12 RBs 110 that are central to the SSB 100 correspond to a bandwidth used by the PSS 102 and/or the SSS 104.

In some embodiments, for transmission bandwidths of less than 5 MHz (e.g., in the context of both 3 MHz and 5 MHz channel bandwidth use), it may be that a lesser number of RBs (e.g., as compared to the 20 RBs 108 illustrated in the SSB 100) are used as a bandwidth for PBCH transmission. Note that in such contexts, RBs for the PSS 102 and/or the SSS 104 may not be punctured.

In some such embodiments, a value X may represent a minimum channel size in RBs for the channel in question. It may be that, for example, X=15 for a 3 MHz channel, while X=25 for a 5 MHz channel. Further, a value Y may represent an SSB size in RBs.

Then, a bandwidth for the PSS and/or the SSS of an SSB may be <=Y, with the further constraint that Y<=X.

In such circumstances, in a first option, a bandwidth used for PBCH transmission in such an SSB may be equivalent to the minimum channel bandwidth on the corresponding band (e.g., 15 RBs in the 3 MHz channel case).

In a second option, a bandwidth used for PBCH transmission, after reduction, may fit into the bandwidth that is provided corresponding to the PSS and/or SSS (e.g., 12 RBs).

In a third option, it may be that a bandwidth used for PBCH transmission falls somewhere between the minimum channel bandwidth and the bandwidth that is provided for PSS and/or SSS.

### Embodiments of Synchronization Raster for Channel Bandwidths Less than 5 MHz

A synchronization raster may include one or more raster entries/raster points identifying frequency(s) where an SSB may be located during the operation of a wireless communication system. It may be that a synchronization raster is known (e.g., pre-configured) at each of the RAN and UE sides within the wireless communication system.

From the UE point of view, the raster entries/raster points of a synchronization raster enable UE acquisition for purposes of accessing a cell. This may occur through the monitoring, by the UE, of one or more raster points (frequencies) of the synchronization raster until an SSB is detected on one of the raster points. The UE then uses information found in the SSB to access a cell corresponding to (using) that SSB.

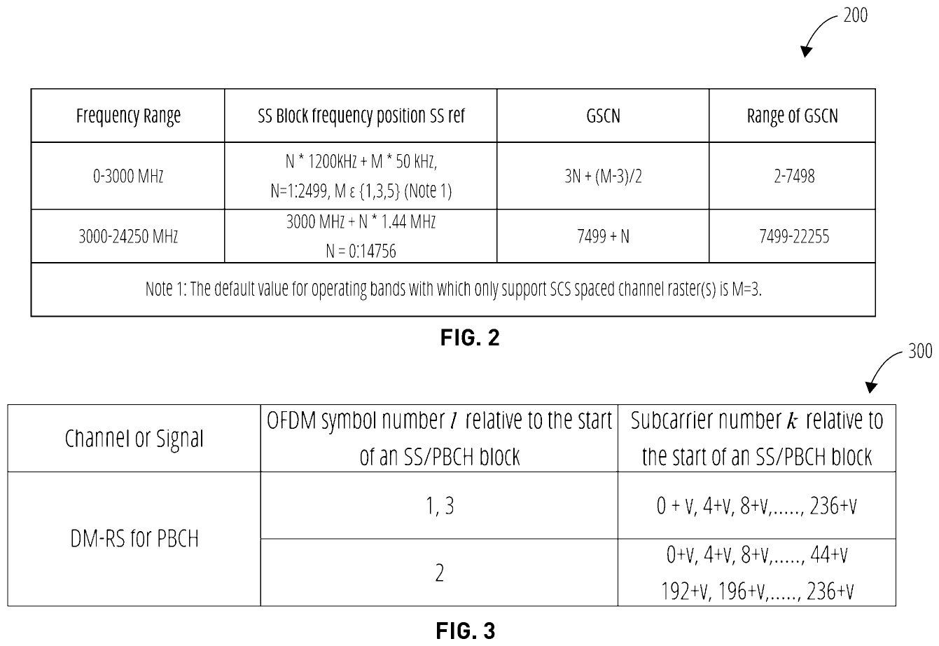

FIG. 2 illustrates a table 200 showing global synchronization channel number (GSCN) parameters for a global frequency network. A synchronization raster design according to the table 200 may be used in some wireless communications systems (e.g., in NR networks for FR1, as specified in 3GPP Technical Specification (TS) 38.101-1, version 18.0.0, section 5.4.3.1 (December 2022)). The synchronization raster design corresponding to the table 200 may assume the use of channel bandwidths of 5 MHz or greater in size. Herein, a synchronization raster for the use of channel bandwidths of 5 MHz or greater in size may be referred to as a “5 MHz” synchronization raster (where the “5 MHz” designation reflects the lower bound for channel bandwidth corresponding to this synchronization raster).

Because of this lower bound of 5 MHz corresponding to a 5 MHz synchronization raster, in cases of wireless communication systems supporting transmission bandwidths of less than 5 MHz (in which a minimum channel bandwidth and/or an SSB bandwidth has changed, e.g., as described herein), it may be beneficial to revisit synchronization raster design. For such circumstances, a number of synchronization rasters having the general form A kHz+N*600 kHz+M*50 kHz, Mϵ{1,3,5}, may be considered (where A=0 for some applicable cases).

Some raster points of a synchronization raster for use to identify sub-5 MHz channels (herein also referred to as a “sub-5 MHz synchronization raster”) developed according to this formula may overlap with raster points for channels according to, e.g., the 5 MHz synchronization raster discussed herein (e.g., raster points of the 5 MHz synchronization raster may be a subset of the raster points of the sub-5 MHz synchronization raster). It is contemplated that in wireless communications systems implementing/using both 5 MHz and sub-5 MHz synchronization rasters (e.g., in a context of both 3 MHz and 5 MHz channel bandwidth use within a wireless communication system), UEs capable of using channels of sub-5 MHz may search for SSBs according to raster points of either/both the sub-5 MHz raster and the 5 MHz synchronization raster. In cases where UE support of sub-5 MHz bandwidths is optional in such wireless communication systems, and where a UE does not support the use of sub-5 MHz channel bandwidths, the UE may access 5 MHz or larger channel cells based on the use of the 5 MHz synchronization raster to identifying SSBs corresponding to channels having channel bandwidths of (at least) 5 MHz.

Note that UEs capable of using channels of sub-5 MHz may be referred to herein as “sub-5 MHz capable UEs.” Further, UEs not supporting the use of sub-5 MHz channel bandwidths may be referred to herein as “5 MHz UEs” (where the “5 MHz” designation reflects the lower bound for a usable channel bandwidth with/by such UEs).

While 5 MHz UEs may only search 5 MHz synchronization rasters (corresponding to channel bandwidths of 5 MHz or larger) and ignore any raster points that are unique to a sub-5 MHz synchronization raster, it may nevertheless be the case that at least some of the raster points of the 5 MHz synchronization raster coincide/overlap with raster points of the sub-5 MHz synchronization raster. In such circumstances, if PBCH puncturing of the SSB for channel identification in a sub-5 MHz channel bandwidth is the only solution available to the network to differentiate this SSB from an SSB for channel identification in a 5 MHz or greater bandwidth, it may ultimately remain the case that the 5 MHz UEs may not be able to reliably differentiate the SSB corresponding to a sub-5 MHz channel bandwidth from an SSB corresponding to a 5 MHz or greater channel bandwidth.

As has been discussed, 5 MHz UEs search only 5 MHz synchronization rasters and ignore the any raster points unique to sub-5 MHz synchronization rasters, and some raster points of 5 MHz synchronization rasters can coincide with raster points for sub-5 MHz synchronization rasters. This overall situation may motivate a clarification for the meaning of “dedicated spectrum” as this term is used in the context of some wireless communication systems, as there are contemplated contexts where sub-5 MHz channels may be deployed in existing bands, and this dual use may be in tension with some understandings of “dedicated spectrum.”

Regardless of any outstanding RF issues within dedicated spectrums (e.g., such as those described above), it has been recognized that problems stemming from the overlap of raster points of 5 MHz synchronization rasters and raster points of sub-5 MHz synchronization rasters may be solved at the (baseband) physical (PHY) channel level.

For example, consider a scenario where a network operator owns at least 5 MHz of spectrum in one of the existing bands (e.g. n8, n26, n28, n100), with other bands possible based on operator request. Further consider that the network operator configures the wireless communication system for operation according to both 3 MHz and 5 MHz channel bandwidths in a same cell. In such cases, mechanisms for ensuring 5 MHz UEs do not attempt to synchronize to the cell based on a receipt of an SSB for a channel having a sub-5 MHz bandwidth while still allowing sub-5 MHz capable UEs to synchronize to the cell on the sub-5 MHz channel bandwidth based on a receipt of an SSB for the channel having the sub-5 MHz bandwidth may be developed.

Further, it may be desirable to develop solutions which allow for 5 MHz UEs to access the network while also allowing sub-5 MHz capable UEs to access the network using channel bandwidths of sub-5 MHz (e.g., through the application and corresponding use of a sub-5 MHz synchronization raster, as described herein) in such a way that minimizes or removes impacts on initial access key performance indicators (KPIs) for the 5 MHz UEs.

In some wireless communication systems, a UE acquisition of a master information block (MIB) during initial access may include a two-step identification process. In some cases, the UE determines a synchronization via a PSS and SSS of an SSB (e.g., timing (symbol and slot) synchronization and frequency synchronization).

Then, the UE may perform a demodulation of a PBCH of the SSB, which may reveal the current system frame number and enable reception of control/data channels (such as PDCCH and/or physical downlink shared channel (PDSCH)). Prior to the PBCH demodulation, detection of a demodulation reference signal (DMRS) of the SSB may need to be performed. As this DMRS may be found in the PBCH of the SSB, it may sometimes be referred to herein as a “PBCH DMRS.”

In some cases, the UE may operate a general search algorithm to identify/use an SSB. The algorithm may use/incorporate one or more of PSS detection, SSS detection, PBCH DRMS detection, and/or PBCH demodulation. Such an algorithm may be, in some cases, proprietary to the UE.

According to some existing wireless communication systems, a PBCH DMRS sequence can include 144 complex-valued symbols r₀, . . . , r₁₄₃. Further, a PBCH DMRS sequence of such systems may be a function of a cell ID

$$( denoted “ {N}_{ID}^{cell} ” )$$

of a cell of the SSB, the last two or three bits of an SSB index (denoted “ī_{SSB}”) for the SSB, and a half-frame index. With respect to these parameters, a initialization value cᵢₙᵢₜ used to generate a pseudo-random sequence (that is ultimately used to generate the DMRS) may be calculated as:

$${c}_{init} = ( {2}^{11} ( {i}_{SSB}^{-} + 1 ) ( floor ( {N}_{I D}^{cell} / 4 ) + 1 ) ) + ( {2}^{6} ( {i}_{SSB}^{-} + 1 ) ) + ( {N}_{ID}^{cell} mod 4 ) .$$

A resource element (RE) mapping of the PBCH DMRS within an SSB may depend on the cell ID. A UE learns a cell ID of the cell upon performing PSS/SSS detection on an SSB. Therefore, the resource mapping of that SSB's PBCH DMRS is also determinable at the UE.

FIG. 3 illustrates a table 300 illustrating formulas for determining a mapping of a PBCH DMRS in an SSB. As illustrated, the mapping for the PBCH DMRS may be determined relative to the start of an SS/PBCH block (i.e., an SSB) with respect to both the time domain and the frequency domain. As shown, the frequency domain positions of the DMRS REs may be determined by using an offset value ν with respect to various pre-configured subcarriers of the SSB (and where the applicable pre-configured subcarriers for various OFDM symbols of the SSB may differ). The offset value ν may be determined with respect to an applicable cell ID according to the formula

$$v = {N}_{ID}^{c e I l} mod 4.$$

### Embodiments of Cell Search Pruning

As has been discussed, 5 MHz UEs search only 5 MHz synchronization rasters and ignore the any raster points unique sub-5 MHz synchronization rasters, and some raster points of 5 MHz synchronization rasters can coincide with raster points for sub-5 MHz synchronization rasters. Accordingly, in such a context, a solution is needed such that 5 MHz UEs are enabled to quickly discard SSBs corresponding to channels having bandwidths of sub-5 MHz when such are transmitted by the network on these overlapping raster points. In particular, it may be desirable to enable a 5 MHz UE to discard such SSBs before PBCH demodulation takes place (including prior to any cross-slot softbit combining, which adds to a mean time to acquire an MIB) so that time and/or computation resources of the UE are conserved.

It has been determined that quickly pruning out sub-5 MHz channel candidates may be achieved by modifying formulations of PBCHs of SSBs corresponding to sub-5 MHz channels. Accordingly, when a 5 MHz UE receives such an SSB, the unique formulation of the PBCH may cause the UE algorithms tailored to identifying 5 MHz channels to fail, meaning that the 5 MHz UE will not recognize the SSB/will not otherwise attempt to converge to the sub-5 MHz channel candidate.

As will be discussed in additional detail herein, in some such cases a mapping of the PBCH DMRS to REs that is particular to sub-5 MHz channels may be used. Further, pseudo-random sequence initialization that is particular to sub-5 MHz channels may be used in some cases. As may be seen from disclosure herein, options for enabling the differentiation of sub-5 MHz channels from 5 MHz or greater channels may include (but are not limited to) these behaviors.

In a first option for differentiation of sub-5 MHz channels from 5 MHz or greater channels, energy detection with respect to the PBCH may be used. In cases where energy detection methods are used, it may be that there is a finite set of one or more nominal channel bandwidths that are sub-5 MHz that may be used within the wireless communication system (rather than an infinite set of potential channel bandwidths corresponding to all mathematically possible values of sub-5 MHz). This arrangement allows the UE hypothesize bandwidth candidates based on known possible bandwidths within the system.

Then, both/either 5 MHz UEs and/or sub-5 MHz capable UEs may measure and compare RE received energy between one or more REs of an SSB that are within the subcarriers aligned with the PSS/SSS of the SSB and one or more REs that is identified as possibly punctured. The one or more REs that are possibly punctured may be RE(s) in symbols used by the PBCH and in subcarriers of the SSB that are known to be used by the PBCH in an SSB that corresponds to a 5 MHz channel bandwidth, but that may not be used by the PBCH in an SSB that corresponds to a sub-5 MHz channel bandwidth (e.g., due to the use of a punctured PBCH having a bandwidth of <20 RBs in such an SSB, as is described herein). Accordingly, it may be understood that in some embodiments, REs identified as possibly punctured are REs on symbols for the PBCH (including symbols where all PBCH REs have been punctured, but where there would otherwise exist PBCH REs if no puncturing had occurred) and on resource blocks that are not used by either of the PSS and/or the SSS of the SSB.

Note that in embodiments, the network may be aware and/or capable of identifying such a RE that may be identified by the UE as possibly punctured, and may accordingly arrange a sub-5 MHz SSB with such RE(s) being punctured such that the SSB is recognized as corresponding to a sub-5 MHz channel by a UE.

The UE may then compare its measurement(s) across to the two types of RE(s). In the case that, for example, high energy is detected in the one or more REs of an SSB that are within the subcarriers aligned with the PSS/SSS of the SSB and low energy is detected in the one or more REs that are identified as possibly punctured, it may be that a 5 MHz UE does recognize and/or otherwise determines not converge on the SSB. On the other hand, a sub-5 MHz capable UE may accordingly identify (e.g., based on the energy difference) that the SSB corresponds to a usable sub-5 MHz channel and appropriately converges to that sub-5 MHz channel.

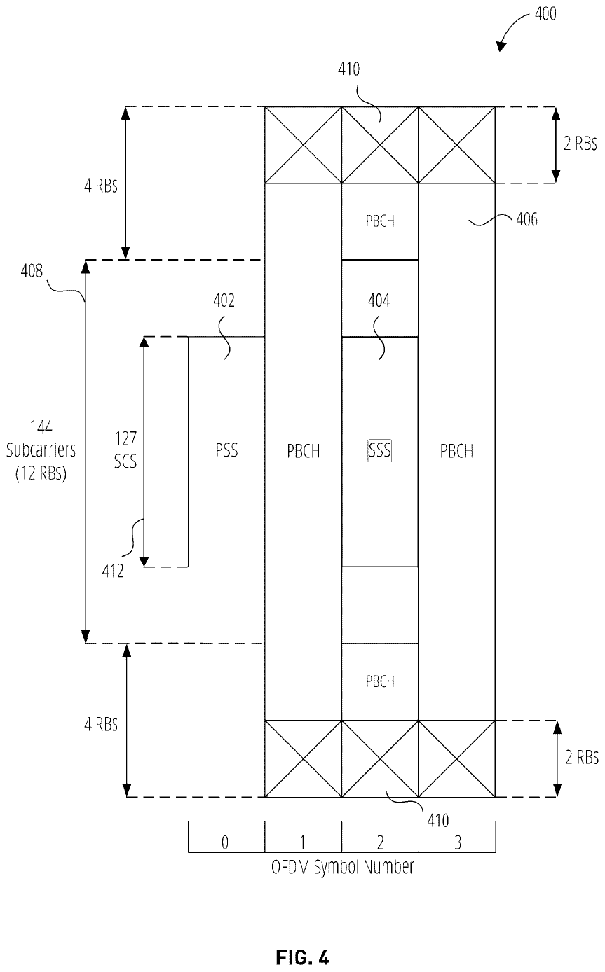

FIG. 4 illustrates an SSB 400 corresponding to a sub-5 MHz channel, according to embodiments herein. The SSB 400 includes a PSS 402, an SSS 404, and a PBCH 406. As illustrated, one or more REs located outside of the 12 RBs 408 used by the PSS 402 and the SSS 404 are punctured 410 (with respect to an SSB that may correspond to a 5 MHz or greater channel bandwidth). Comparisons of measurement(s) of one or more REs in a symbol for the PBCH (e.g., symbols for a PBCH in an SSB that would correspond to a 5 MHz or greater channel bandwidth, which in some cases are symbol numbers 1, 2, and 3) that is in the region that is punctured 410 versus measurement(s) of one or more REs that are in symbol(s) used in the SSB 400 and on one or more of the subcarriers 412 that are used by one or more of the PSS 402 and/or the SSS 404 can then be used to by a UE to determine whether or not to converge to the channel, in the manner described herein.

In a second option for differentiation of sub-5 MHz channels from 5 MHz or greater channels, aspects related to PBCH rate matching may be used. In such cases, instead of using a PBCH that is punctured with respect to the case of a PBCH for an SSB corresponding to a 5 MHz channel (e.g., as may be the case in some embodiments of the first option just described), a PBCH of an SSB corresponding to a sub-5 MHz channel may be remapped into non-punctured REs. In other words, it may be that the PBCH is sequentially mapped within fewer than 20 RBs without puncturing (e.g., there are no intermediate sequential gaps with respect to the use of the DMRS sequence within REs of the PBCH).

In such cases, PBCH data and/or DMRS RE(s) may be found in different positions as compared to a PBCH for an SSB corresponding to a 5 MHz channel. Accordingly, a 5 MHz UE will not recognize and/or will otherwise determine not to converge on the SSB. On the other hand, a sub-5 MHz capable UE may accordingly identify that the SSB corresponds to a usable sub-5 MHz channel and appropriately converges to that sub-5 MHz channel.

In a third option for differentiation of sub-5 MHz channels from 5 MHz or greater channels, PBCH remapping may be used. In some cases, it may be that additional RBs for the PBCH may be added beyond a third symbol past a PSS of an SSB. For example, in some cases, it may be that such additional RBs for the PBCH are added to OFDM symbols number 4 and 5 (where OFDM symbol 0 is a first symbol used by the SSB).

In such cases, PBCH data and/or DMRS RE(s) may be remapped as compared to a case of a PBCH for an SSB corresponding to a 5 MHz channel. For example, for SSBs corresponding to some sub-5 MHz channel bandwidths, the PBCH may be mapped on the central 12 RBs of OFDM symbols number 1, 3, 4, and 5 (again, where OFDM symbol 0 is a first symbol used by the SSB).

Then, because 5 MHz UEs search for DMRS in symbols 1, 2 and 3 (corresponding to the expected formulation of an SSB corresponding to a 5 MHz channel bandwidth), they will not recognize and/or will otherwise determine not to converge on the SSB. On the other hand, a sub-5 MHz capable UE may accordingly identify (e.g., based on the use of OFDM symbols 4 and 5 for the PBCH/for the PBCH DMRS) that the SSB corresponds to a usable sub-5 MHz channel and appropriately converges to that sub-5 MHz channel.

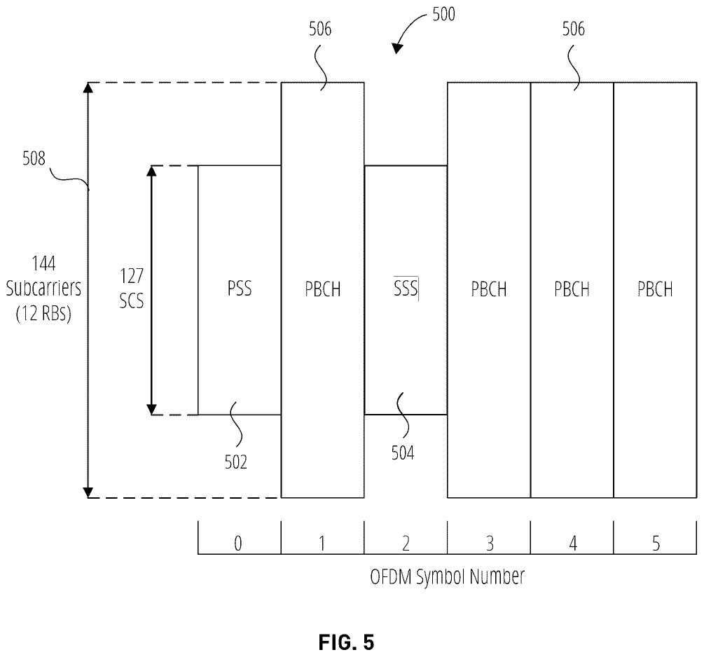

FIG. 5 illustrates an SSB 500 corresponding to a sub-5 MHz channel, according to embodiments herein. The SSB 500 includes a PSS 502, an SSS 504, and a PBCH 506. As illustrated, the PBCH 506 is mapped on the central 12 RBs 508 of OFDM symbols number 1, 3, 4, and 5 of the SSB 500, as illustrated. The arrangement of the PBCH 506 as compared to the UE's expectations for a PBCH can then be used by the UE to determine whether or not to converge to the channel, in the manner described herein.

In a fourth option for differentiation of sub-5 MHz channels from 5 MHz or greater channels, an independent formula for an offset value ν with respect to preconfigured subcarriers of the SSB that is used for mapping of a PBCH DMRS in an SSB corresponding to a sub-5 MHz channel bandwidth may be used. This formula may be different than a formula that is used for an offset value ν with respect to preconfigured subcarriers of the SSB for mapping a PBCH DMRS in an SSB corresponding to a 5 MHz or greater channel bandwidth. For example, instead of using a formula

$$v = {N}_{ID}^{cell} mod 4$$

to determine an offset value ν used for mapping DMRS REs with respect to pre-configured subcarriers of the SSB (e.g., as is discussed elsewhere herein with respect to use for a 5 MHz or greater channel bandwidth), a different formula

$$v = ( {N}_{ID}^{c e l l} + α ) mod 4 ,$$

where α={1, 2, 3}, may be used to determine the offset value ν.

The use of the second formula causes the PBCH DMRS REs of an SSB corresponding to a sub-5 MHz channel bandwidth to be found in different positions than they would be found in an SSB corresponding to a 5 MHz or greater channel bandwidth. Any PBCH data REs may then be mapped to the PBCH.

Because 5 MHz UEs search for a PBCH DMRS in frequency locations of an SSB corresponding to the presumed use of an offset value

$$ν = {N}_{ID}^{cell} mod 4 ,$$

they will not find the PBCH DRMS within the SSB, and will accordingly they will not recognize and/or will otherwise determine not to converge on the SSB. On the other hand, a sub-5 MHz capable UE may accordingly identify (e.g., based on an identification of a PBCH DMRS that is at frequency locations corresponding to the use of an offset value

$$v = ( {N}_{ID}^{c e l l} + α ) mod 4 ,$$

where α={1, 2, 3}) that the SSB corresponds to a sub-5 MHz channel and appropriately converges to the sub-5 MHz channel.

In a fifth option for differentiation of sub-5 MHz channels from 5 MHz or greater channels, it may be that the locations of PBCH data and PBCH DMRS REs are the same as between an SSB corresponding to a 5 MHz or greater channel and an SSB corresponding to a sub-5 MHz channel. However, in the case of an SSB corresponding to a sub-5 MHz channel, the PBCH DMRS may be generated according to a sequence (e.g., a pseudo-random sequence) that is an initialized by an initialization value used for/corresponding to communications that occur in a sub-5 MHz channel bandwidths. This initialization value may be a value of cᵢₙᵢₜ for PBCH DMRS sequence generation for an SSB corresponding to a channel bandwidth of sub-5 MHz that is different than a value of cᵢₙᵢₜ that is used for PBCH DMRS sequence generation for an SSB corresponding to a channel bandwidth of 5 MHz or greater.

Then, a UE may use, inter alia, correlation based techniques to identify whether an SSB corresponds to a channel having a sub-5 MHz bandwidth or a channel having a 5 MHz or greater bandwidth. For example, an inner product correlation between a received DMRS and an expected DMRS according to one or the other of the sub-5 MHz bandwidth and 5 MHz or greater bandwidth cases may be performed, and the error may be analyzed to determine whether if the received DMRS is consistent with the expected DMRS according to the tested bandwidth case.

Then, in the case that the SSB corresponds to a channel having a bandwidth of sub-5 MHz, because a 5 MHz UE would not perform such correlations using expected DMRSs corresponding to the use of the cᵢₙᵢₜ for PBCH DMRS sequence generation for an SSB corresponding to a channel bandwidth of sub-5 MHz, the determined error at the 5 MHz UE may be high, and the 5 MHz UE will accordingly not recognize and/or will otherwise determine not to converge on the SSB. On the other hand, for the same SSB, a sub-5 MHz capable UE may perform such correlations using expected DMRSs corresponding to the use of the cᵢₙᵢₜ for PBCH DMRS sequence generation for an SSB corresponding to a channel bandwidth of sub-5 MHz. Therefore, the determined error at the sub-5 MHz capable UE may be low, and the sub-5 MHz capable UE may accordingly identify that the SSB corresponds to a usable sub-5 MHz channel and appropriately converge to that sub-5 MHz channel.

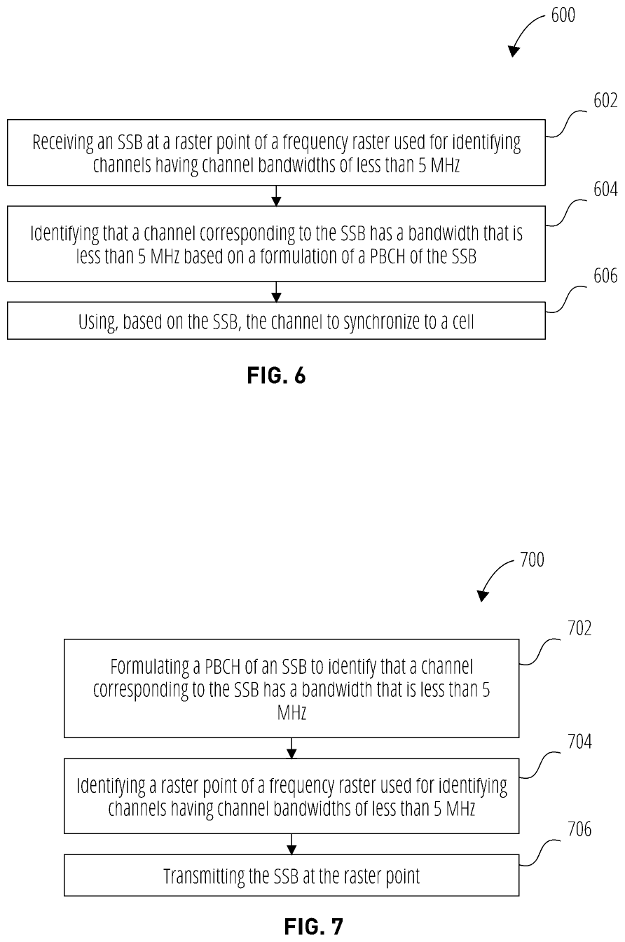

FIG. 6 illustrates a method 600 of a UE, according to embodiments herein. The method 600 includes receiving 602 an SSB at a raster point of a frequency raster used for identifying channels having channel bandwidths of less than 5 MHz. The method 600 further includes identifying 604 that a channel corresponding to the SSB has a bandwidth that is less than 5 MHz based on a formulation of a PBCH of the SSB. The method 600 further includes using 606, based on the SSB, the channel to synchronize to a cell.

In some embodiments of the method 600, the identifying that the channel corresponding to the SSB has the bandwidth that is less than 5 MHz based on the formulation of the PBCH of the SSB includes: measuring a first energy of a first resource element that is in a symbol for the PBCH and on a first subcarrier that is not in a set of resource blocks used by a PSS and an SSS of the SSB; measuring a second energy of a second resource element that is in a symbol used by the SSB and on a subcarrier that is used by the one of the PSS and the SSS; and determining that the first resource element is not included in the PBCH based on a difference between the first energy and the second energy.

In some embodiments of the method 600, the formulation of the PBCH used to identify that the channel corresponding to the SSB has the bandwidth that is less than 5 MHz comprises that the PBCH is sequentially mapped within fewer than 20 RBs without puncturing.

In some embodiments of the method 600, the formulation of the PBCH used to identify that the channel corresponding to the SSB has the bandwidth that is less than 5 MHz comprises that one or more REs of the PBCH is mapped beyond a third symbol past a PSS of the SSB.

In some embodiments of the method 600, the formulation of the PBCH used to identify that the channel corresponding to the SSB has the bandwidth that is less than 5 MHz comprises that DMRS REs of the PBCH are arranged within the PBCH according to an offset value ν with respect to preconfigured subcarriers of the SSB, where the offset value ν is determined according to

$$v = ( {N}_{ID}^{c e l l} + α ) mod 4 ,$$

where α={1, 2, 3}.

In some embodiments of the method 600, the formulation of the PBCH used to identify that the channel corresponding to the SSB has the bandwidth that is less than 5 MHz comprises that a DMRS of the PBCH reflects a generation according to a sequence that is initialized by an initialization value used for communications that occur in the channels having the channel bandwidths of less than 5 MHz.

FIG. 7 illustrates a method 700 of a RAN, according to embodiments herein. The method 700 includes formulating 702 a PBCH of an SSB to identify that a channel corresponding to the SSB has a bandwidth that is less than 5 MHz. The method 700 further includes identifying 704 a raster point of a frequency raster used for identifying channels having channel bandwidths of less than 5 MHz. The method 700 further includes transmitting 706 the SSB at the raster point.

In some embodiments of the method 700, the formulating the PBCH of the SSB to identify that the channel corresponding to the SSB has a bandwidth that is less than 5 MHz comprises: identifying a resource element that is to be measured by a user equipment (UE); and formulating the PBCH without using the resource element.

In some embodiments of the method 700, the formulating the PBCH to identify that the channel corresponding to the SSB has the bandwidth that is less than 5 MHz comprises sequentially mapping the PBCH within fewer than 20 RBs without puncturing.

In some embodiments of the method 700, the formulating the PBCH to identify that the channel corresponding to the SSB has the bandwidth that is less than 5 MHz comprises mapping one or more REs of the PBCH beyond a third symbol past a PSS of the SSB.

In some embodiments of the method 700, the formulating the PBCH to identify that the channel corresponding to the SSB has the bandwidth that is less than 5 MHz comprises arranging DMRS REs of the PBCH within the PBCH according to an offset value ν with respect to preconfigured subcarriers of the SSB, where the offset value ν is determined according to

$$v = ( {N}_{ID}^{c e l l} + α ) mod 4 ,$$

where α={1, 2, 3}.

In some embodiments of the method 700, the formulating the PBCH to identify that the channel corresponding to the SSB has the bandwidth that is less than 5 MHz comprises generating a DMRS of the PBCH according to a sequence that is initialized by an initialization value used for communications that occur in the channels having the channel bandwidths of less than 5 MHz.

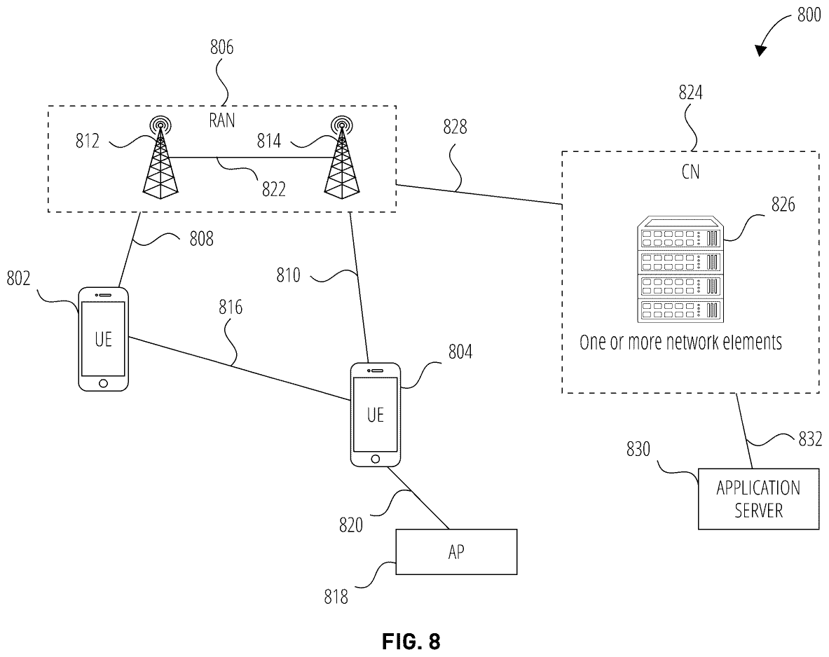

FIG. 8 illustrates an example architecture of a wireless communication system 800, according to embodiments disclosed herein. The following description is provided for an example wireless communication system 800 that operates in conjunction with the LTE system standards and/or 5G or NR system standards as provided by 3GPP technical specifications.

As shown by FIG. 8, the wireless communication system 800 includes UE 802 and UE 804 (although any number of UEs may be used). In this example, the UE 802 and the UE 804 are illustrated as smartphones (e.g., handheld touchscreen mobile computing devices connectable to one or more cellular networks), but may also comprise any mobile or non-mobile computing device configured for wireless communication.

The UE 802 and UE 804 may be configured to communicatively couple with a RAN 806. In embodiments, the RAN 806 may be NG-RAN, E-UTRAN, etc. The UE 802 and UE 804 utilize connections (or channels) (shown as connection 808 and connection 810, respectively) with the RAN 806, each of which comprises a physical communications interface. The RAN 806 can include one or more base stations (such as base station 812 and base station 814) that enable the connection 808 and connection 810.

In this example, the connection 808 and connection 810 are air interfaces to enable such communicative coupling, and may be consistent with RAT(s) used by the RAN 806, such as, for example, an LTE and/or NR.

In some embodiments, the UE 802 and UE 804 may also directly exchange communication data via a sidelink interface 816. The UE 804 is shown to be configured to access an access point (shown as AP 818) via connection 820. By way of example, the connection 820 can comprise a local wireless connection, such as a connection consistent with any IEEE 802.11 protocol, wherein the AP 818 may comprise a Wi-Fi® router. In this example, the AP 818 may be connected to another network (for example, the Internet) without going through a CN 824.

In embodiments, the UE 802 and UE 804 can be configured to communicate using orthogonal frequency division multiplexing (OFDM) communication signals with each other or with the base station 812 and/or the base station 814 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 812 or base station 814 may be implemented as one or more software entities running on server computers as part of a virtual network. In addition, or in other embodiments, the base station 812 or base station 814 may be configured to communicate with one another via interface 822. In embodiments where the wireless communication system 800 is an LTE system (e.g., when the CN 824 is an EPC), the interface 822 may be an X2 interface. The X2 interface may be defined between two or more base stations (e.g., two or more eNBs and the like) that connect to an EPC, and/or between two eNBs connecting to the EPC. In embodiments where the wireless communication system 800 is an NR system (e.g., when CN 824 is a 5GC), the interface 822 may be an Xn interface. The Xn interface is defined between two or more base stations (e.g., two or more gNBs and the like) that connect to 5GC, between a base station 812 (e.g., a gNB) connecting to 5GC and an eNB, and/or between two eNBs connecting to 5GC (e.g., CN 824).

The RAN 806 is shown to be communicatively coupled to the CN 824. The CN 824 may comprise one or more network elements 826, which are configured to offer various data and telecommunications services to customers/subscribers (e.g., users of UE 802 and UE 804) who are connected to the CN 824 via the RAN 806. The components of the CN 824 may be implemented in one physical device or separate physical devices including components to read and execute instructions from a machine-readable or computer-readable medium (e.g., a non-transitory machine-readable storage medium).

In embodiments, the CN 824 may be an EPC, and the RAN 806 may be connected with the CN 824 via an S1 interface 828. In embodiments, the S1 interface 828 may be split into two parts, an S1 user plane (S1-U) interface, which carries traffic data between the base station 812 or base station 814 and a serving gateway (S-GW), and the S1-MME interface, which is a signaling interface between the base station 812 or base station 814 and mobility management entities (MMEs).

In embodiments, the CN 824 may be a 5GC, and the RAN 806 may be connected with the CN 824 via an NG interface 828. In embodiments, the NG interface 828 may be split into two parts, an NG user plane (NG-U) interface, which carries traffic data between the base station 812 or base station 814 and a user plane function (UPF), and the S1 control plane (NG-C) interface, which is a signaling interface between the base station 812 or base station 814 and access and mobility management functions (AMFs).

Generally, an application server 830 may be an element offering applications that use internet protocol (IP) bearer resources with the CN 824 (e.g., packet switched data services). The application server 830 can also be configured to support one or more communication services (e.g., VoIP sessions, group communication sessions, etc.) for the UE 802 and UE 804 via the CN 824. The application server 830 may communicate with the CN 824 through an IP communications interface 832.

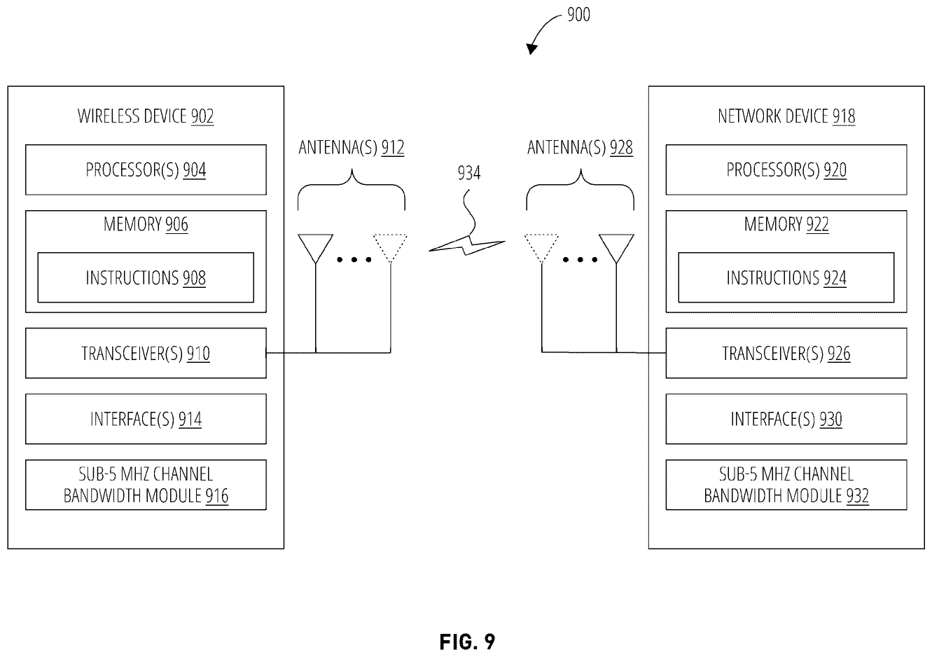

FIG. 9 illustrates a system 900 for performing signaling 934 between a wireless device 902 and a network device 918, according to embodiments disclosed herein. The system 900 may be a portion of a wireless communications system as herein described. The wireless device 902 may be, for example, a UE of a wireless communication system. The network device 918 may be, for example, a base station (e.g., an eNB or a gNB) of a wireless communication system.

The wireless device 902 may include one or more processor(s) 904. The processor(s) 904 may execute instructions such that various operations of the wireless device 902 are performed, as described herein. The processor(s) 904 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 902 may include a memory 906. The memory 906 may be a non-transitory computer-readable storage medium that stores instructions 908 (which may include, for example, the instructions being executed by the processor(s) 904). The instructions 908 may also be referred to as program code or a computer program. The memory 906 may also store data used by, and results computed by, the processor(s) 904.

The wireless device 902 may include one or more transceiver(s) 910 that may include RF transmitter circuitry and/or receiver circuitry that use the antenna(s) 912 of the wireless device 902 to facilitate signaling (e.g., the signaling 934) to and/or from the wireless device 902 with other devices (e.g., the network device 918) according to corresponding RATs.

The wireless device 902 may include one or more antenna(s) 912 (e.g., one, two, four, or more). For embodiments with multiple antenna(s) 912, the wireless device 902 may leverage the spatial diversity of such multiple antenna(s) 912 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 902 may be accomplished according to precoding (or digital beamforming) that is applied at the wireless device 902 that multiplexes the data streams across the antenna(s) 912 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 902 may implement analog beamforming techniques, whereby phases of the signals sent by the antenna(s) 912 are relatively adjusted such that the (joint) transmission of the antenna(s) 912 can be directed (this is sometimes referred to as beam steering).

The wireless device 902 may include one or more interface(s) 914. The interface(s) 914 may be used to provide input to or output from the wireless device 902. For example, a wireless device 902 that is a UE may include interface(s) 914 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 910/antenna(s) 912 already described) that allow for communication between the UE and other devices and may operate according to known protocols (e.g., Wi-Fi®, Bluetooth®, and the like).

The wireless device 902 may include a sub-5 MHz channel bandwidth module 916. The sub-5 MHz channel bandwidth module 916 may be implemented via hardware, software, or combinations thereof. For example, the sub-5 MHz channel bandwidth module 916 may be implemented as a processor, circuit, and/or instructions 908 stored in the memory 906 and executed by the processor(s) 904. In some examples, the sub-5 MHz channel bandwidth module 916 may be integrated within the processor(s) 904 and/or the transceiver(s) 910. For example, the sub-5 MHz channel bandwidth module 916 may be implemented by a combination of software components (e.g., executed by a DSP or a general processor) and hardware components (e.g., logic gates and circuitry) within the processor(s) 904 or the transceiver(s) 910.

The sub-5 MHz channel bandwidth module 916 may be used for various aspects of the present disclosure, for example, aspects of FIG. 1 through FIG. 7. The sub-5 MHz channel bandwidth module 916 may be configured to, for example, receive an SSB at a raster point of a frequency raster used for identifying channels having channel bandwidths of less than 5 MHz, identify that a channel corresponding to the SSB has a bandwidth that is less than 5 MHz based on a formulation of a PBCH of the SSB, and/or use, based on the SSB, the channel to synchronize to a cell, in the manners described herein.

The network device 918 may include one or more processor(s) 920. The processor(s) 920 may execute instructions such that various operations of the network device 918 are performed, as described herein. The processor(s) 920 may include one or more baseband processors implemented using, for example, a CPU, a DSP, an ASIC, a controller, an FPGA device, another hardware device, a firmware device, or any combination thereof configured to perform the operations described herein.

The network device 918 may include a memory 922. The memory 922 may be a non-transitory computer-readable storage medium that stores instructions 924 (which may include, for example, the instructions being executed by the processor(s) 920). The instructions 924 may also be referred to as program code or a computer program. The memory 922 may also store data used by, and results computed by, the processor(s) 920.

The network device 918 may include one or more transceiver(s) 926 that may include RF transmitter circuitry and/or receiver circuitry that use the antenna(s) 928 of the network device 918 to facilitate signaling (e.g., the signaling 934) to and/or from the network device 918 with other devices (e.g., the wireless device 902) according to corresponding RATs.

The network device 918 may include one or more antenna(s) 928 (e.g., one, two, four, or more). In embodiments having multiple antenna(s) 928, the network device 918 may perform MIMO, digital beamforming, analog beamforming, beam steering, etc., as has been described.

The network device 918 may include one or more interface(s) 930. The interface(s) 930 may be used to provide input to or output from the network device 918. For example, a network device 918 that is a base station may include interface(s) 930 made up of transmitters, receivers, and other circuitry (e.g., other than the transceiver(s) 926/antenna(s) 928 already described) that enables the base station to communicate with other equipment in a core network, and/or that enables the base station to communicate with external networks, computers, databases, and the like for purposes of operations, administration, and maintenance of the base station or other equipment operably connected thereto.

The network device 918 may include a sub-5 MHz channel bandwidth module 932. The sub-5 MHz channel bandwidth module 932 may be implemented via hardware, software, or combinations thereof. For example, the sub-5 MHz channel bandwidth module 932 may be implemented as a processor, circuit, and/or instructions 924 stored in the memory 922 and executed by the processor(s) 920. In some examples, the sub-5 MHz channel bandwidth module 932 may be integrated within the processor(s) 920 and/or the transceiver(s) 926. For example, the sub-5 MHz channel bandwidth module 932 may be implemented by a combination of software components (e.g., executed by a DSP or a general processor) and hardware components (e.g., logic gates and circuitry) within the processor(s) 920 or the transceiver(s) 926.

The sub-5 MHz channel bandwidth module 932 may be used for various aspects of the present disclosure, for example, aspects of FIG. 1 through FIG. 7. The sub-5 MHz channel bandwidth module 932 may be configured to, for example, formulate a PBCH of an SSB to identify that a channel corresponding to the SSB has a bandwidth that is less than 5 MHz, identify a raster point of a frequency raster used for identifying channels having channel bandwidths of less than 5 MHz, and/or transmit the SSB at the raster point, in the manners described herein.

Embodiments contemplated herein include an apparatus comprising means to perform one or more elements of the method 600. This apparatus may be, for example, an apparatus of a UE (such as a wireless device 902 that is a UE, as described herein).

Embodiments contemplated herein include one or more non-transitory computer-readable media comprising instructions to cause an electronic device, upon execution of the instructions by one or more processors of the electronic device, to perform one or more elements of the method 600. This non-transitory computer-readable media may be, for example, a memory of a UE (such as a memory 906 of a wireless device 902 that is a UE, as described herein).

Embodiments contemplated herein include an apparatus comprising logic, modules, or circuitry to perform one or more elements of the method 600. This apparatus may be, for example, an apparatus of a UE (such as a wireless device 902 that is a UE, as described herein).

Embodiments contemplated herein include an apparatus comprising: one or more processors and one or more computer-readable media comprising instructions that, when executed by the one or more processors, cause the one or more processors to perform one or more elements of the method 600. This apparatus may be, for example, an apparatus of a UE (such as a wireless device 902 that is a UE, as described herein).

Embodiments contemplated herein include a signal as described in or related to one or more elements of the method 600.

Embodiments contemplated herein include a computer program or computer program product comprising instructions, wherein execution of the program by a processor is to cause the processor to carry out one or more elements of the method 600. The processor may be a processor of a UE (such as a processor(s) 904 of a wireless device 902 that is a UE, as described herein). These instructions may be, for example, located in the processor and/or on a memory of the UE (such as a memory 906 of a wireless device 902 that is a UE, as described herein).

Embodiments contemplated herein include an apparatus comprising means to perform one or more elements of the method 700. This apparatus may be, for example, an apparatus of a base station (such as a network device 918 that is a base station, as described herein).

Embodiments contemplated herein include one or more non-transitory computer-readable media comprising instructions to cause an electronic device, upon execution of the instructions by one or more processors of the electronic device, to perform one or more elements of the method 700. This non-transitory computer-readable media may be, for example, a memory of a base station (such as a memory 922 of a network device 918 that is a base station, as described herein).

Embodiments contemplated herein include an apparatus comprising logic, modules, or circuitry to perform one or more elements of the method 700. This apparatus may be, for example, an apparatus of a base station (such as a network device 918 that is a base station, as described herein).

Embodiments contemplated herein include an apparatus comprising: one or more processors and one or more computer-readable media comprising instructions that, when executed by the one or more processors, cause the one or more processors to perform one or more elements of the method 700. This apparatus may be, for example, an apparatus of a base station (such as a network device 918 that is a base station, as described herein).

Embodiments contemplated herein include a signal as described in or related to one or more elements of the method 700.

Embodiments contemplated herein include a computer program or computer program product comprising instructions, wherein execution of the program by a processing element is to cause the processing element to carry out one or more elements of the method 700. The processor may be a processor of a base station (such as a processor(s) 920 of a network device 918 that is a base station, as described herein). These instructions may be, for example, located in the processor and/or on a memory of the base station (such as a memory 922 of a network device 918 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a user equipment (UE), comprising:
receiving a synchronization signal (SS)/physical broadcast channel (PBCH) block (SSB) at a raster point of a frequency raster used for identifying channels having channel bandwidths of less than 5 megahertz (MHz);
identifying that a channel corresponding to the SSB has a bandwidth that is less than 5 MHz based on a formulation of a PBCH of the SSB; and
using, based on the SSB, the channel to synchronize to a cell.

2. The method of claim 1, wherein the identifying that the channel corresponding to the SSB has the bandwidth that is less than 5 MHz based on the formulation of the PBCH of the SSB comprises:
measuring a first energy of a first resource element that is in a symbol for the PBCH and on a first subcarrier that is not in a set of resource blocks used by a primary synchronization signal (PSS) and a secondary synchronization signal (SSS) of the SSB;
measuring a second energy of a second resource element that is in a symbol used by the SSB and on a subcarrier that is used by the one of the PSS and the SSS; and
determining that the first resource element is not included in the PBCH based on a difference between the first energy and the second energy.

3. The method of claim 1, wherein the formulation of the PBCH used to identify that the channel corresponding to the SSB has the bandwidth that is less than 5 MHz comprises that the PBCH is sequentially mapped within fewer than 20 resource blocks (RBs) without puncturing.

4. The method of claim 1, wherein the formulation of the PBCH used to identify that the channel corresponding to the SSB has the bandwidth that is less than 5 MHz comprises that one or more resource elements (REs) of the PBCH is mapped beyond a third symbol past a primary synchronization signal (PSS) of the SSB.

5. The method of claim 1, wherein the formulation of the PBCH used to identify that the channel corresponding to the SSB has the bandwidth that is less than 5 MHz comprises that demodulation reference signal (DMRS) resource elements (REs) of the PBCH are arranged within the PBCH according to an offset value ν with respect to preconfigured subcarriers of the SSB, where the offset value ν is determined according to
$$v = ( {N}_{ID}^{c e l l} + α ) mod 4 ,$$
where α={1, 2, 3}.

6. The method of claim 1, wherein the formulation of the PBCH used to identify that the channel corresponding to the SSB has the bandwidth that is less than 5 MHz comprises that a demodulation reference signal (DMRS) of the PBCH reflects a generation according to a sequence that is initialized by an initialization value used for communications that occur in the channels having the channel bandwidths of less than 5 MHz.

7. A method of a radio access network (RAN), comprising:
formulating a physical broadcast channel (PBCH) of a synchronization signal (SS)/physical broadcast channel (PBCH) block (SSB) to identify that a channel corresponding to the SSB has a bandwidth that is less than 5 megahertz (MHz);
identifying a raster point of a frequency raster used for identifying channels having channel bandwidths of less than 5 MHz; and
transmitting the SSB at the raster point.

8. The method of claim 7, wherein the formulating the PBCH of the SSB to identify that the channel corresponding to the SSB has a bandwidth that is less than 5 MHz comprises:
identifying a resource element that is to be measured by a user equipment (UE); and
formulating the PBCH without using the resource element.

9. The method of claim 7, wherein the formulating the PBCH to identify that the channel corresponding to the SSB has the bandwidth that is less than 5 MHz comprises sequentially mapping the PBCH within fewer than 20 resource blocks (RBs) without puncturing.

10. The method of claim 7, wherein the formulating the PBCH to identify that the channel corresponding to the SSB has the bandwidth that is less than 5 MHz comprises mapping one or more resource elements (REs) of the PBCH beyond a third symbol past a primary synchronization signal (PSS) of the SSB.

11. The method of claim 7, wherein the formulating the PBCH to identify that the channel corresponding to the SSB has the bandwidth that is less than 5 MHz comprises arranging demodulation reference signal (DMRS) resource elements (REs) of the PBCH within the PBCH according to an offset value ν with respect to preconfigured subcarriers of the SSB, where the offset value ν is determined according to
$$v = ( {N}_{ID}^{c e l l} + α ) mod 4 ,$$
where α={1, 2, 3}.

12. The method of claim 7, wherein the formulating the PBCH to identify that the channel corresponding to the SSB has the bandwidth that is less than 5 MHz comprises generating a demodulation reference signal (DMRS) of the PBCH according to a sequence that is initialized by an initialization value used for communications that occur in the channels having the channel bandwidths of less than 5 MHz.

13. An apparatus of a user equipment (UE), comprising:
one or more processors; and
a memory storing instructions that, when executed by the one or more processors, configure the UE to:
receive a synchronization signal (SS)/physical broadcast channel (PBCH) block (SSB) at a raster point of a frequency raster used for identifying channels having channel bandwidths of less than 5 megahertz (MHz);
identify that a channel corresponding to the SSB has a bandwidth that is less than 5 MHz based on a formulation of a PBCH of the SSB; and
use, based on the SSB, the channel to synchronize to a cell.

14. The apparatus of claim 13, wherein the instructions, when executed by the one or more processors, configure the UE to identify that the channel corresponding to the SSB has the bandwidth that is less than 5 MHz based on the formulation of the PBCH of the SSB by:
measuring a first energy of a first resource element that is in a symbol for the PBCH and on a first subcarrier that is not in a set of resource blocks used by a primary synchronization signal (PSS) and a secondary synchronization signal (SSS) of the SSB;
measuring a second energy of a second resource element that is in a symbol used by the SSB and on a subcarrier that is used by the one of the PSS and the SSS; and
determining that the first resource element is not included in the PBCH based on a difference between the first energy and the second energy.

15. The apparatus of claim 13, wherein the formulation of the PBCH used to identify that the channel corresponding to the SSB has the bandwidth that is less than 5 MHz comprises that the PBCH is sequentially mapped within fewer than 20 resource blocks (RBs) without puncturing.

16. The apparatus of claim 13, wherein the formulation of the PBCH used to identify that the channel corresponding to the SSB has the bandwidth that is less than 5 MHz comprises that one or more resource elements (REs) of the PBCH is mapped beyond a third symbol past a primary synchronization signal (PSS) of the SSB.

17. The apparatus of claim 13, wherein the formulation of the PBCH used to identify that the channel corresponding to the SSB has the bandwidth that is less than 5 MHz comprises that demodulation reference signal (DMRS) resource elements (REs) of the PBCH are arranged within the PBCH according to an offset value ν with respect to preconfigured subcarriers of the SSB, where the offset value ν is determined according to
$$v = ( {N}_{ID}^{c e l l} + α ) mod 4 ,$$
where α={1, 2, 3}.

18. The apparatus of claim 13, wherein the formulation of the PBCH used to identify that the channel corresponding to the SSB has the bandwidth that is less than 5 MHz comprises that a demodulation reference signal (DMRS) of the PBCH reflects a generation according to a sequence that is initialized by an initialization value used for communications that occur in the channels having the channel bandwidths of less than 5 MHz.

19-36. (canceled)
